(19) United States
(12) Patent Application Publication
(10) Pub. No.: US 2024/0281915 A1
(43) Pub. Date: Aug. 22, 2024

(54) Grouping and Recommendations System and Method

(71) Applicant: Renaissance Learning, Inc., Wisconsin Rapids, WI (US)

(72) Inventors: Ajay Mathew, Vancouver, WA (US); Julianne Robar, Lac des Loups (CA); Zecheng Chang, Long Island City, NY (US); Bruce Bray, Camas, WA (US); Jon Medin, Nerstrand, MN (US); Selvedin Alic, Eagan, MN (US); Robert Zieroth, Wisconsin Rapids, WI (US); Eric Stickney, Waunakee, WI (US); Eric Swanson, Oregon, WI (US); Jon Stelman, Brooklyn, NY (US)

(21) Appl. No.: 18/444,591

(22) Filed: Feb. 16, 2024

Related U.S. Application Data
(60) Provisional application No. 63/485,468, filed on Feb. 16, 2023.

(51) Int. Cl. G06Q 50/20; G06Q 10/0631

(52) U.S. Cl. CPC G06Q 50/20; G06Q 10/06311

(57) ABSTRACT

A system and method trained to identify areas of learning challenge and essential concepts and generate recommendations with customized practice and instructional materials to address and capture all students' needs. The recommendations are generated based on a data-based progression of educational content. The system creates models for each student, which are adjustable or modifiable to teacher planning preferences and teacher knowledge of the student, and can adapt to interruptions and lost instructional time due to uncontrollable circumstances (e.g., global pandemic.). A graphical interface displays recommendations to instructors or students for selection. A separate clustering algorithm uses an underlying student model to group students who would benefit from working on the same educational activities for optimal learning. The recommendations may be aligned to selected educational goals or a general list of effective choices for any given student or a group of students. The grouping arrangement may be influenced by the teacher who may choose from any number of evidence-based grouping and peer-tutoring configurations depending on the teacher's preference, the goal of a particular lesson, and students' achievement goals. Both the grouping and recommendations are influenced by how students with similar characteristics and performance history have shown the most growth.

### CROSS REFERENCE TO RELATED APPLICATIONS

This application claims priority under 35 USC § 119(e) to the provisional U.S. Application No. 63/485,468 titled “Grouping and Recommendations System and Method,” filed on, Feb. 16, 2023, wherein the entirety of the provisional application is herein incorporated by reference.

### BACKGROUND

### 1. Field of the Invention

The present invention relates to a system and methods for grouping students based on identified criteria, for example, areas of learning challenge and essential concepts, and for generating recommendations for students in educational scenarios. The system and methods are implemented in a dynamic technology platform to elevate the instructional process, at any level, anywhere in the world (e.g., district, state, national, or global) and to generate recommendation models for each student to better focus their skills, develop essential skills, and to address problem indicators gleaned from aggregating data from many inputs and to group students for progress based on similar criteria.

### Description of the Related Art

With digital instruction on the rise, technical tools to accelerate student growth and experiences are also on the rise. Teachers, instructors, and other educators, within the last twenty years if not more, are exposed to many different types of educational materials, courses, and curriculums in effect nationally and globally. At the same time, the pace at which individual students develop can vary depending upon myriad criteria. With all the materials and tools that currently exist, teachers can guide different students or groups of students by online tools and platforms. The pandemic accelerated the need for better learning experiences online. The shift to more interactive and diverse learning models will likely only continue.

As is well known, in the United States and other countries, guiding education is a state function. The landscape of education in the United States is characterized by diversity. This includes diversity in the socioeconomic backgrounds of students, curricula, types of programs, size of classes, and resources available to the schools. This diversity is generated, in part, by a tradition of local control of schools by boards of education, which are composed of members chosen through local elections, and it is these boards of education that bear the responsibility for overseeing the funding of schools. The typical public schools in the United States have three levels: elementary, junior high, and senior high. A composite profile representing typical schools does not exist. Different schools adopt curriculum standards or guidelines proposed by state departments of education, rather than by a national body. One exception is the influential set of national guidelines developed by the National Council of Teachers of Mathematics (“NCTM”).

Many schools have used these guidelines to upgrade their mathematics curriculum and have enthusiastically embraced the NCTM guidelines. These guidelines describe the accomplishments that would be expected of students at various grade levels. In addition, a set of national education goals, known as Goals 2000, has served to provide goals to be attained by the nation in the next several years. It should be recognized that “standards” represent established levels of achievement; in other instances, it may represent commonly shared sets of academic subject content, such as those embodied in state curriculum guidelines.

Curriculum guidelines in particular have been used to set standards in many states and have been linked to state-administered achievement tests. However, any discussion of standards in the United States must also include a description of the more informal mechanisms by which schools maintain and promote desired levels of achievement. Achievement levels for schools and for students have traditionally been set by community expectations, and communities continue to influence curriculum and instructional decisions made at the school level.

Schools usually offer courses with varying levels of difficulty for core academic subjects, such as math and science. Curriculum content in these courses reflected different achievement expectations and, as a result, also reflected the diversity of a school's academic standards. Schools with the most highly stratified course offerings typically provided a very rigorous curriculum in their advanced-level courses.

It is clear that as the digital universe of educational content expands and the complexity of digital curriculums increases, the teaching and learning exercises and experiences become more challenging every day for the diverse student body. Moreover, different students develop at varying rates.

Given the many different standards and variations, existing digital instruction levels and varying student development pace, technology can help provide insights to teachers and educators to enable them to assist and support students to develop to their best capability with resources customized to their abilities.

### SUMMARY

The present technology created overcomes the deficiencies and limitations of prior systems and methods, at least in part by, providing a recommendations and groupings system and method. The recommendations and groupings system and method are configured to identify “focus” skills, “essential” skills, and problem indicators for automated assessment, intervention, and placement into appropriate practice exercises and levels. The recommendations and grouping system and methods comprise a unique user interface for skill assessment and providing recommendations with a skills search tool. The recommendations and groupings system, is further configured to outline and generate predictive rosters and to determine and synchronize timing.

The recommendations and groupings system and method in accordance with the present invention identifies areas of learning challenge and essential concepts relevant to each student and recommends customized practice and instructional materials to address and capture each student's needs, to improve all students' needs.

In accordance with some embodiments, a recommendations engine generates recommendations based on a data-based progression of educational content that is on the same scale as the assessment used to identify where students are in their learning journeys or paths.

The recommendations engine generates a model for each student to be adjustable to teacher planning preferences and teacher knowledge of the student, and adapts to one or more interruptions and lost instructional time due to uncontrollable circumstances (e.g., global pandemic.). The recommendations engine is coupled to a graphical interface configured to display recommendations to instructors or students for selection.

In accordance with some embodiments, a separate clustering algorithm uses an underlying student model to group students who would benefit from working on the same educational activities for optimal learning. The recommendations may be aligned to selected educational goals or a general list of effective choices for any given student or a group of students. The grouping arrangement may be influenced by the teacher who may choose from any number of evidence-based grouping and peer-tutoring configurations depending on the teacher's preference, the goal of a particular lesson, and students' achievement goals.

In accordance with some embodiments, both the grouping and recommendations are influenced by how students with similar characteristics and performance history have shown the most growth. The collection and modeling of past data on achievement, rates of growth, intervention, daily skills practice, and other relevant student information is used to continuously increase precision and adjust recommendations to maximize student growth.

### BRIEF DESCRIPTION OF THE DRAWINGS

The present invention is illustrated by way of example, and not by way of limitation in the figures of the accompanying drawings in which like reference numerals are used to refer to the same or similar elements.

FIG. 1 is a high-level block diagram illustrating a distributed environment in which user devices for use by users (e.g., students, teachers, educators or the like) are coupled by communication networks with the recommendations and grouping system in accordance with the present invention.

FIGS. 2A-2C is a block diagram illustrating the recommendations and grouping system with its various sub-systems, modules, and engines. FIG. 2A illustrates the “Products” and “Product Data” subsystems. FIG. 2B illustrates additional subsystems including the Student Grouping and Recommendation Engine and teacher planning model. FIG. 2C illustrates additional subsystems including recommended target grouping system and the progressive activity plan grouping recommendations engine.

FIG. 3 is a block diagram illustrating an example configuration of the recommendations and grouping system and its various components.

FIG. 4 is a block diagram illustrating an example configuration of the application process and its various components.

FIG. 5 is a flow chart illustrating an example overall method of the functionalities of the recommendations and grouping engine.

FIG. 6 is a continuing flow chart illustrating further operations of the recommendations and grouping system in accordance with some embodiments of the present invention.

### DETAILED DESCRIPTION

The systems and methods of this technology as illustrated in the figures provide integrated and automated solutions to enhance the learning environment. The recommendations and groupings system and methods with software modules and engines are configured to identify “focus” skills, essential skills, and problem indicators with respect to students for automated assessment, intervention, and placement into appropriate practice exercises. The recommendations and grouping system and method comprise a user interface for skill assessment and recommendations with a skills search tool. The recommendations and groupings system are further configured to outline and generate predictive rosters and to determine and synchronize timing.

The recommendations and groupings system and methods identify areas of learning challenge and essential concepts and recommend customized practice and instructional materials to address and capture each student's needs and collective needs of all students. A recommendations engine generates recommendations based on a data-based progression of educational content that is on the same scale as the assessment used to identify where students are in their respective learning journeys or paths. The recommendations engine is configured to generate a model for each student to be adjustable to teacher planning preferences and teacher knowledge of the student, and adapts to one or more interruptions and lost instructional time due to uncontrollable circumstances (e.g., global pandemic.). Each of these criteria serves as a data feed to generate a model The recommendations engine is coupled to a graphical interface configured to display recommendations to instructors or students for selection.

The recommendations and grouping engine, is coupled to a separate clustering algorithm that uses an underlying student model to group students who would benefit from working on the same educational activities for optimal learning. The recommendations may be aligned to selected educational goals or a general list of effective choices for any given student or a group of students. The grouping arrangement may be influenced by the teacher who may choose from any number of evidence-based grouping and peer-tutoring configurations depending on the teacher's preference, the goal of a particular lesson, and students' achievement goals.

Both the grouping and recommendations functionalities are influenced by how students with similar characteristics and performance history have shown the most growth. The collection and modeling of past data on achievement, rates of growth, intervention, daily skills practice, and other relevant student information is used to continuously increase precision and adjust recommendations to maximize student growth.

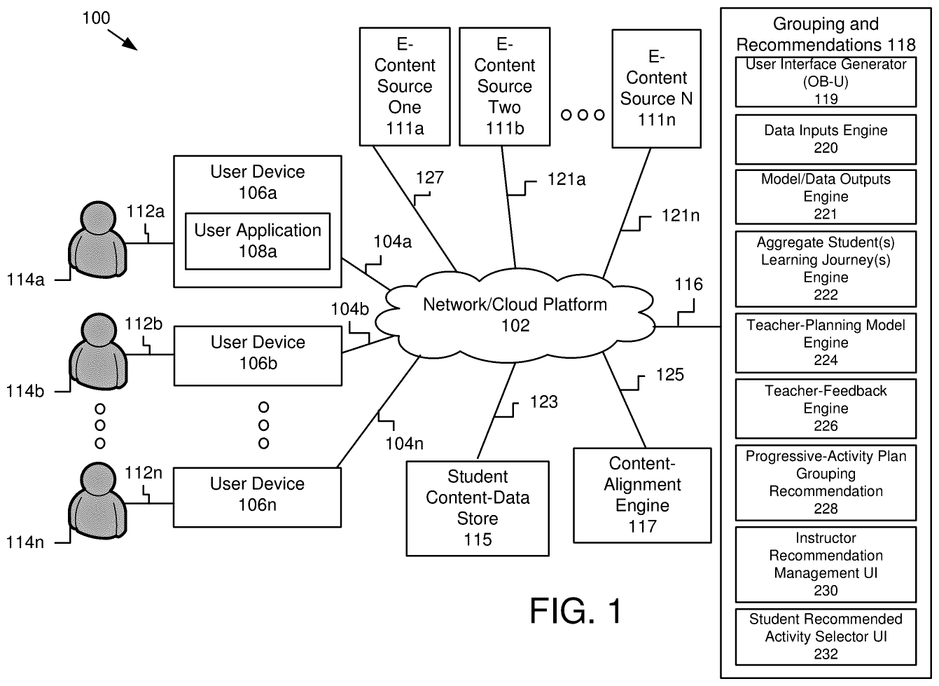

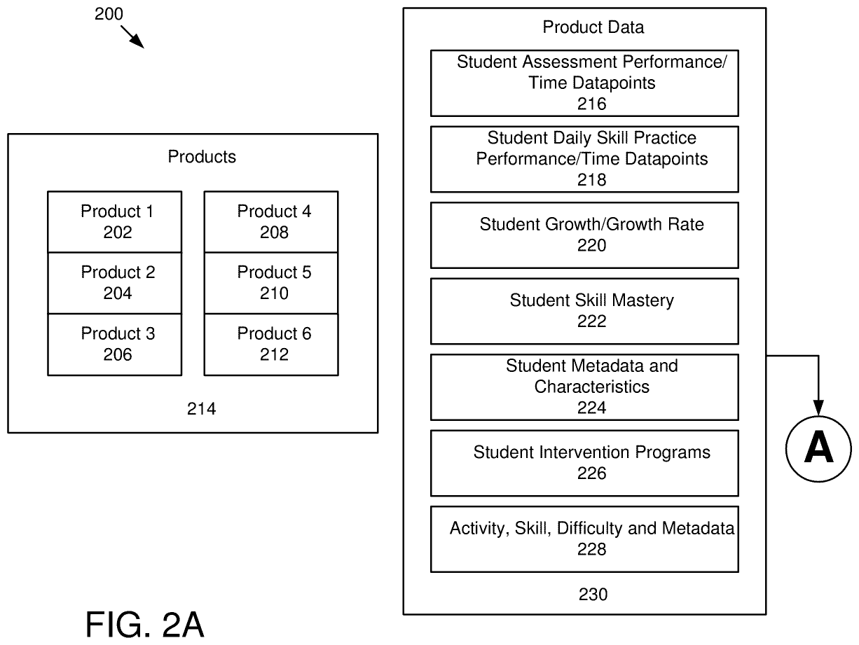

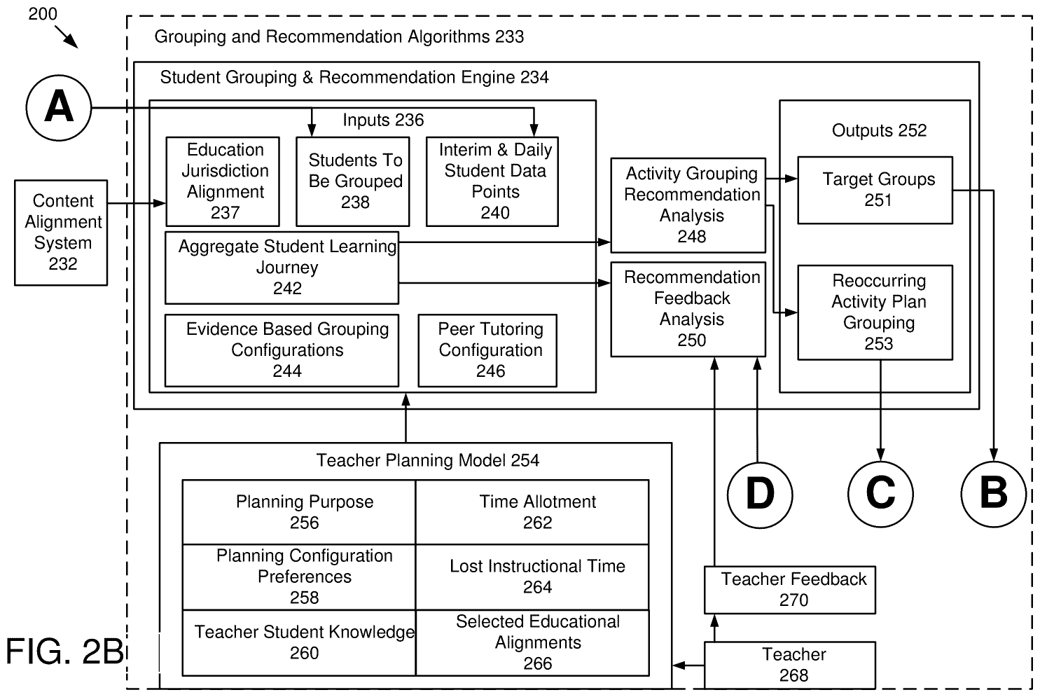

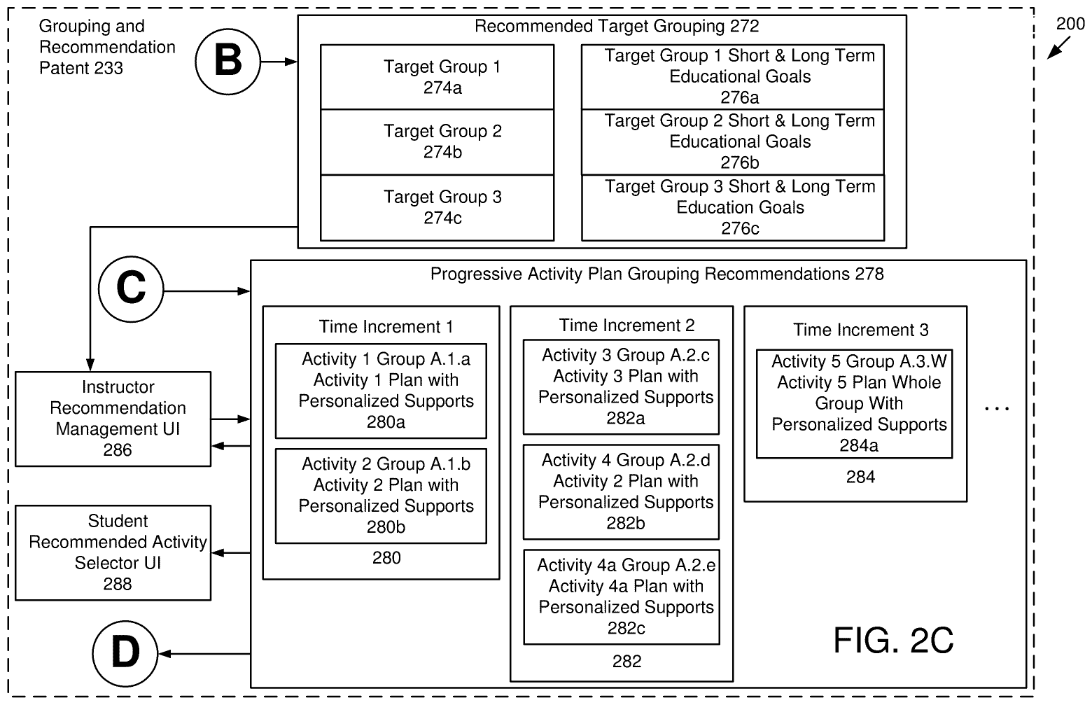

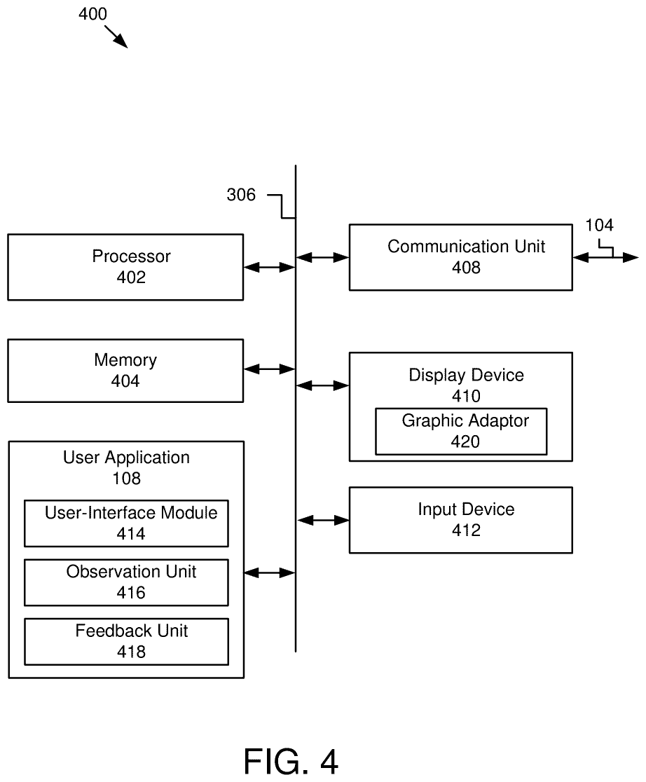

FIG. 1 illustrates a general distributed environment (e.g., cloud-based or a client-server architecture or an environment in which parts of all of the innovative technology described here may be implemented in devices or applications) as designated generally by reference numeral 100, with users designated by reference numerals 114a, 114b, through 114n, who may be students, teachers, administrators, instructors, educators, or anyone in the educational environment or scenario, using user devices, designated by reference numerals 106a, 106b, through 106n. In some embodiments, the user devices are configured to interact with the recommendations and grouping (“RG”) system 118, via a network 102 (e.g., a cloud platform or any network configured to couple remote devices). Each of the user devices 106a-106n may have a user application 108a (illustrated only in user device 106a as one example) configured to operate and perform the functions of this innovative technology. User communications or input actions flow via signal lines 112a, 112b, through 112n, respectively, to the user devices, 106a, 106b, through 106n, and through lines 104a, 104b, through 104n, into the network 102 (and beyond). In some embodiments, user input may interact through signal line 116, via the network/cloud platform 102 with the recommendations and grouping (RG) system (or engine) 118. The recommendations and grouping (RG) system 118 integrates one or more functionalities of various sub-systems, each a software module or engine operating and hardware, including but not limited to, a user interface generator 119, data inputs engine 220 from various products and data feeds (e.g., see FIGS. 2A-2C), model/data outputs engine 221, aggregate student(s) learning journey(s) engine 222, a teacher-planning model engine 224, a teacher-feedback engine 226, a progressive-activity plan grouping recommendation 228, an instructor recommendation management user interface (UI) 230, and a student recommended activity selector 232. Access to each of these subsystems (modules or engines) is accomplished via an observation engine, which is illustrated in FIG. 1 as a part of the recommendations and grouping user interface 119 (see FIG. 1). The observation engine in the user interface generator 119 (also 416 in FIG. 4) is configured to show different and dynamic views via a display unit or device (see 410 in FIG. 4) of the user devices 106a-106n to the teacher instructor or anyone else using any of the user devices. The design of the user interface generator 119 facilitates display of various student models generated for specific students. It should be recognized by those skilled in the art that a student model may be generated by defining inputs that represent data sets on a student's current state of knowledge (e.g., indicated by the data inputs engine 220) and introducing data sets on variable student-specific criteria or teacher preferences to map a future course of action as an outcome (e.g., delivered by the model/data outputs engine 221).

In some instances, the student model may represent data sets on the student's current state of knowledge from a teacher or from dynamic real time data inputs. Those data sets may include a representation of the knowledge, concepts, and skills the student has acquired either fully or partially. A teacher's knowledge of each particular student may be maintained in a knowledge graph with decisioning software. It should be recognized by those skilled in the art, that a knowledge graph, also known as a semantic network, represents a network of real-world entities, for instance, objects, events, situations, or concepts, and illustrates the relationship between them. This information is usually stored in a graph database and visualized as a graph structure, prompting the term knowledge “graph.” In many instances, a knowledge graph is made up of three main components including nodes, edges, and labels. Any object, place, or person can be a node. An edge defines the relationship between the nodes. For example, a node may represent a teacher or a student. It should be recognized that the definitions of knowledge graphs may vary. Knowledge graphs as referred to herein comprise datasets from various sources, which frequently differ in structure. Schemas, identities and context work together to provide structure to diverse data. Schemas provide the framework for the knowledge graph, identities classify the underlying nodes appropriately, and the context determines the setting in which that knowledge exists. These components help distinguish words with multiple meanings. This allows products, like search engine algorithms, to determine the difference between words based on context. Knowledge graphs configured to work with machine learning, may utilize natural language processing (“NLP”) to construct a comprehensive view of nodes, edges, and labels through semantic enrichment processes. As data is ingested, these processes allows knowledge graphs to identify individual objects and understand the relationships between different objects. This working knowledge is then compared and integrated with other datasets, which are relevant and similar in nature. Once a knowledge graph is complete, it allows question answering and search systems to retrieve and reuse comprehensive answers to given queries. The system here eliminates manual data collection and integration work to support educational decision-making. The data integration efforts around knowledge graphs may also support the creation of new knowledge, establishing connections between data points that may not have been realized before.

The data sets may also include the representation of a given student's special skills and needs. Moreover, there may be a mechanism to represent misconceptions, bugs, or erroneous information, which the student might have acquired. For instance, in a particular subject, the student model may represent variables, for instance, that the student has understood certain educational concepts, yet the student (erroneously) is either confused by or struggling with other similar concepts. The model may also infer actions, for instance, that this particular student prefers delayed over immediate feedback. All sorts of data sets and/or information may be used to provide optimal teaching interventions or to track student status and progress. To generate the student models, assumptions or theories on how students learn and how they represent in memory what they have learned may also be considered. Specific contents of the student model may be inferred by asking the students questions and analyzing their reactions toward prompts of the RG system 118 or the way they are going to tackle a problem. These models may consider educational measurements by obtaining observations from student responses (e.g., provided from the student recommended activity selector UI 232 in FIG. 2) in order to make inferences about their knowledge and skills. Reliable instruments are critical in this effort. The way in which information from assessments is captured, analyzed, and ultimately used, strongly influences the student model.

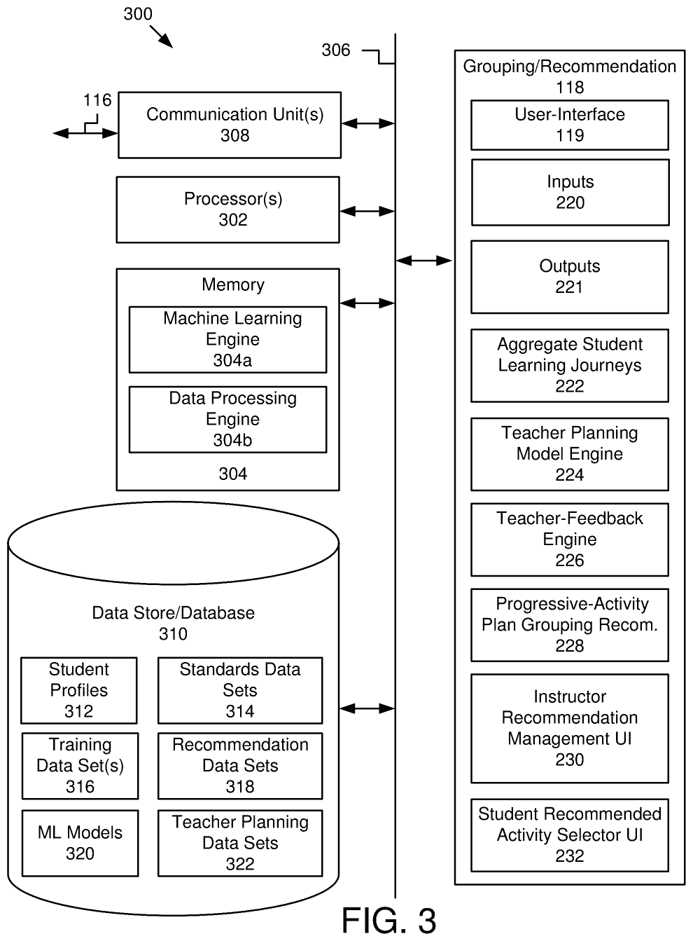

The RG system 118 may include one or more servers with one or more processors (302 in FIG. 3) and one or more storage devices (data store 310) storing data or instructions executable by the one or more processors 302. For example, the RG system 118 may be a single server, an array of servers or any other computing device, or a group of computing devices, with data processing, storing, and communication capabilities. In some embodiments, the RG system 118 may be a virtual server (i.e., a virtual machine) implemented via software. For example, the virtual server operates in a host server environment and accesses the physical hardware of the host server including, for example, a processor, memory, storage, network interfaces, etc., via an abstraction layer (e.g., a virtual machine manager). It should be understood that the RG system 118 may be made up of any combination of devices and servers, or only one device or server. The RG system 118 may interact with the user devices 106a-106n or other third-party servers, for example, a content-alignment server 117 or e-content servers represented as E-Content Source One 111a, E-Content Source Two 111b, through E-Content Source N 111n. The numeral “N” represents that any number of E-Content servers of any type may be used. Each of these sources have or provide access to content on specific students. The RG system 118 may also be coupled to a Student Content-Data Store 115, or other servers that are typical in the distributed educational system 100. All the illustrated components in the distributed environment 100 may communicate via the network or cloud platform 102, or may be coupled to and interact with any of these entities via a direct data connection.

In some embodiments, the entities of the distributed system 100 including the RG system 118 and the other servers may be implemented using cloud-based architectures where one or more computer functions are performed by remote computing systems and devices at the request of a local computer device. For example, a user device 106a may be a computing device having a limited set of hardware and/or software resources and may access hardware and/or software resources provided across the network 102 by other computer devices and resources, such as other user devices 106b, the content-alignment server 117, the RG system 118, or any other computing resources. The user device 106a may access these resources through a user application 108a, such as a web browser or customized application, and the results of any computer functions or resources may be delivered through the user application 108a to the user by the user device 106a, such as those described. Other architectures know to those skilled in the art may also be used.

In some embodiments, the RG system 118 may be a cloud-based distributed computing system with dynamically scalable and virtualizable resources. In some embodiments, components of the RG system 118 may be implemented on user devices. In some embodiments, the RG system 118 may be implemented in a cloud and user devices. Various functionalities of the RG system 118, including the functionalities of the user interface generator 119, the data inputs engine 220, the model/data outputs engine 221, the aggregate student(s) learning journey(s) engine 222, the teacher-planning model engine 224, the teacher-feedback engine 226, the progressive-activity plan grouping recommendation 228, the instructor recommendation management user interface (UI) 230, and the student recommended activity selector 232 may be carried out and supplemented by computing systems and devices distributed over the network 102. Although only one automated RG system 118 is shown, multiple servers/platforms 118 may be included in the system 100 for regional or global reach or for specific purposes as desired. In some embodiments, the RG system 118 may be implemented as a control tool in a user device 106a. In some embodiments, all or parts of the RG system 118 may be implemented in the user device 106a.

Each of the content sources (one, two, and N as illustrated) designated by reference numerals 111a, 111b, and 111n is a computing device and/or system for transmitting or providing access to electronic resources or data stored in or available through the content data store 115 to the other entities in the environment 100. In some embodiments, these servers cooperate with the RG system 118 to provide recommendations or grouping data to a user 114a (e.g., teacher or instruction) for consumption. For example, the RG system 118 may transmit or provide access to a file (e.g., a webpage or content structured on a website) to a user device 106a for display to the user 114a. In some instances, the file may include code (e.g., a video player) executable to receive a video and/or audio stream (e.g., an electronic resource in a particular language) from the language servers (any one of language source one, two, or N illustrated) and render it for display to the user 114a. In the depicted embodiment, the student content-data store 115 is coupled to the network 102 via signal line 123 for communication with the other entities of the distributed environment 100. The student content-data store 115 is also coupled to the language sources to access electronic resources and other data stored therein. In some embodiments, the student content-data store 115 is a hardware server including a processor, memory, and network communication capabilities. In other embodiments, the student content-data server 115 is a virtual server.

In some embodiments, the e-content sources 111a-111n may include a database management system (“DBMS”) executable by a processor 302 (in FIG. 3) to manage a collection of records, files, and objects including the media objects. For example, the database could be a structured query language (“SQL”) DBMS. In these embodiments, the RG system 118 and/or the student content-data store 115 are coupled to the e-content sources 111a through 111n, via the bus 306 to store data in multi-dimensional tables having rows and columns, and manipulate, i.e., insert, query, update and/or delete, rows of data using programmatic operations (e.g., SQL queries and statements). Any of this data may be used to create or generate student models or adjust them based on any circumstantial instances (e.g., interruptions due to pandemic or the like).

The content-alignment engine 117 may be a server hosting a network-based software application operable to provide various services or functionalities, and to send data to and receive data from the RG system 118, the content data store 115, and the user devices 106-106n via the network 102. In the depicted embodiment, the content-alignment server 117 is coupled to the network 102 via signal line 125 for communication with the other entities of the RG system 100. The content-alignment engine 117 is also coupled to the content data store 115 by signal lines 125 and 123 for accessing and storing data. In some embodiments, the content-alignment server 117 is a single server, an array of servers, or any other computing device, or group of computing devices, with data processing, storing and communication capabilities. In other embodiments, content-alignment server 117 is a virtual server.

The content-alignment engine 117 may provide access to data stored in the data store 115 that is associated with users (e.g., teachers or students) of the RG system 118 or may couple to remote servers with data specific to educational jurisdictions, for example, the different states in the United States.

In some embodiments, the data stored in the student content-data store 115 may include assessment data, achievement data, student data, teacher data, standards data, course data, etc., and the content-alignment engine 117 may include a software application for providing secure access to this type of data to the RG system 118 over the network 102 via an API.

For example, in an educational setting, the “demographics” data may include student demographics data that may be used to discern specifics educational criteria for the demographics in a particular school district. This data may be segmented across any educational agency, for example a school district, a school, a classroom, a grade, etc. The “achievement” data may include standardized test scores of particular students for use by educators to determine their level or ability. The student data may include all types of student-specific data, including but not limited to, student assessment performance, student daily skills practice, student growth rates, student skill master, student metadata and characteristics, student intervention programs, and student activity, skills, and difficulty or challenge (for a particular subject or overall) metadata. Any data for the student may be used to generate student-specific models (e.g., via the model/data outputs engine 221). As is recognized by those skilled in the art, to generate the student models, all relevant data may be gathered (e.g., by designating data paths) and provided via the data inputs engine 220 to the modeling software. The requirements for the outcomes should be defined based on educational goals, desired outcomes etc. The next steps involve segregating the requirements into specific processes. In this step of logical modeling, different actions users can take are defined, and the manner in which the recommendations and grouping engine/application responds, along with any other processes it might conduct in the background, are defined. Generating a student model may also include creating a conceptual data model, by which the various types of data inputs are structured to meet the model outcomes. As one example, in some embodiments, the aggregate student(s) learning journey engine 222 may perform functions that aggregate a learning journey for students who share the same educational goal, are at a similar level etc.

Generating the student models (e.g., by the model/data outputs engine 221) also requires identifying entities. In some scenarios, it may be useful to translate each identity into a distinct database table. For example, the rows may represent each individual instance of the entity, like a specific student, subject, or group. Each column may represent a specific attribute that should be stored for each of the entities (e.g., students). At this point, the specific variables are determined, their labels, format, and rules that will apply to them for generating each specific model. Another critical step is to identify the data sources, for example, the E-Content sources 111a, 111b, through 111n, student content-data store 115 etc. Yet another step is to define the relationships between the entities. For example, the model/data outputs engine 221 may include a clustering algorithm used to identify all students requiring similar processing tasks and groups them together. The final steps are to ensure that the physical models generated operate effectively, with ensuring data integrity and are maintained to operate with new functionalities that may be introduced.

Student models that are generated may be adjusted based data sets on teacher preferences or knowledge of the student. The teacher may adjust the student models generated by the model/data outputs engine 221 based on publicly-shared data, teacher preferences, teacher assessments of students (e.g., aggregated from surveys, reviews, etc.), or standards etc. The standards data may include standards compiled and approved by a governing organization or institution, which define the levels of attainment pupils much reach to be considered acceptably educated. It should be recognized that the fifty states in the U.S. may have unique needs and standards for education. The standards may require a varying range of skills. It should also be recognized that education standards, objectives, or goals vary across countries and also regions within countries. Different standards may be based on states or districts, or alternatively, provenance, agency, department, dioecy, federal etc. There also exist international educational frameworks and organizations. For example, the International Standard Classification of Education (ISCED) is a statistical framework for organizing information on education maintained by the United Nations Educational, Scientific and Cultural Organization (UNESCO). There are efforts underway to globalize educational standards. As another example, the European Education Area fosters collaboration among the European Union Member States to build more resilient and inclusive national education and training systems. Standardizing global educational organizations and practices via management systems help manage processes and activities to meet global objectives and goals. Data sets on all types of standards may be stored in the student content-data store 115 in the data store/database 310, which in an illustration of a large data store or database 310 with different data sets. Data sets on various standards may be stored in the data section 314 in the data store/database 310.

As an example, agencies may include the “Wisconsin Department of Public Instruction,” “Kansas State Department of Education,” “New York Department of Education,” and so on. In some embodiments, a local instance of the data stored in the content data-store 115 may be included in the data-store 115 or data store/database 310. For example, a batch program operating periodically (every few minutes, hours, days, weeks, etc.) may retrieve a refreshed version of the data stored in the data store 115. In addition, data on different courses in a particular curriculum may be stored in different languages.

Referring now to FIGS. 2A-2C, the RG system 118 is illustrated in an operating educational environment represented generally by reference numeral 200. The educational content may be from diverse sources and in a multitude of different languages as illustrated. As illustrated, examples of products with educational content may include “Product 1” (202), “Product 2” (204), “Product 3” (206), “Product 4” (208), “Product 5” (210), and “Product 6” (212). The products data 230 may include Student Assessment Performance/Time Datapoints 216, Student Daily Skills Practice Performance/Time Datapoints 218, Student Growth/Growth Rate 220, Student Skill Mastery 222, Student Metadata and Characteristics 224, Student Intervention Programs 226, and Activity Skill, Difficulty, and Metadata 228. The educational content provided or accessed may include exercises, instructional plans or academic standards, provided via the E-content Sources One, Two through N (FIG. 1, 111a-111n). The student content-data store 115 (FIG. 1) may comprise data relevant to student educational goals, progress, and targets. The student specific electronic content may be assessed for objectives and the metadata may be stored.

As illustrated in FIG. 2B, the product data sets 230 flow via connector “A” to (is provided to or accessible by) the student grouping or recommendation engine or module (part of the recommendations and grouping system 118 in FIG. 1). The product data 230 also flows as input to (is provided to or accessible by) modules that group students and serve as daily datapoints, i.e., “students to be grouped,” and “interim and daily student data points.” The input flow is channeled through data inputs engine 220. Any data from a content alignment system 232 (e.g., also 117 in FIG. 1) flows through an education jurisdiction alignment 237. A module or engine 222 is configured to aggregate the student learning journey, shown as block “Aggregate student learning journey” in FIG. 1. The Student Grouping and Recommendation Engine 234 further comprises evidence-based grouping configurations engine 244 and a peer tutoring configuration engine 246.

In some embodiments, a teacher planning model 254 is coupled to the various modules described above and further may comprise software modules, algorithms, and data representative of a planning purpose, planning configuration preferences, and teacher student knowledge 260 (illustrated in a first column) and time allotment 262, lost instructional time 264, and selected educational alignments 266 (illustrated in a second column). The teacher planning model 254 may be provided by a teacher, who may also provide teacher feedback 270 via a connection to the recommendation feedback analysis module 250. In some embodiments, the teacher planning model 254 comprises the planning purpose engine 256, the time allotment engine 262, the planning configuration preferences engine 258, the lost instructional time engine 264, the teacher student knowledge engine or graph 260, and the selected educational alignments engine 266.

The recommendation feedback analysis module 250 and an activity grouping recommendation analysis module 248 are coupled to the model/data outputs engine 221, which may comprise target groups module 251 and a recurring activity plan grouping module 253. Each of these connects to subsystems in FIG. 2C via connectors “B” and “C.” In some embodiments, the target groups engine 251 couples via connector “B” to the recommended target grouping engine 272. In some embodiments, the reoccurring activity plan grouping engine 253 couples to the progressive activity plan grouping recommendations engine 278 (FIG. 2C). Referring now to FIG. 2C, data from the target groups module 251 flows into a recommended target grouping module 272 with various sub-modules, including but not limited to, “Target Group 1” 274a, “Target Group 2” 274b, “Target Group 3” 274c, “Target Group 1 short and long term Educational Goals” 276a, “Target Group 2 short and long term Educational Goals” 276b, and “Target Group 3 short and long term Educational Goals” 276c. Data flows from the recurring activity plan grouping module 253 into a progressive activity plan grouping recommendations module 278. This progressive activity plan grouping recommendations module 278 is structured with a “Time Increment 1” 280, which may store data on a particular event, for example, “Activity 1 Group A.1.a,” which may be an Activity 1 plan with personalized supports 280a. Another example is “Activity 2 Group A.1.b,” which may be an “Activity 2 plan with personalized supports illustrated in block 280b. Another “Time Increment 2” is illustrated with an “Activity 3 Group A.2.c.,” of an Activity 3 Group plan with personalized supports, designated by reference numeral 282a. Yet another “Activity 4 Group A.2.d.,” is illustrated with an Activity 4a plan with personalized supports, designated by reference numeral 282b. Another component “Time Increment 3” may include “Activity 5 Group A.3.W,” directed to an Activity 5 Plan Whole Group with personalized supports, designated by reference numeral 284. Output from the Recommended Target Grouping module 272 and the Progressive Activity Plan Grouping Recommendations module 278 flow into the Instructional or Instructor Recommendation Management User Interface (UI) 286 and the Student Recommended Activity Selector UI 288. Output from the progressive activity plan grouping recommendations 278 also flows via connector “D” to recommendations feedback analysis module or engine 250.

As illustrated in FIG. 3 in addition to FIG. 1, the RG system 118 comprises the user interface 119, the data inputs engine 220 from various products and data feeds (see FIG. 2), the model/data outputs engine 221, aggregate student(s) learning journey(s) engine 222 for identified students, the teacher-planning model engine 224, the teacher-feedback engine 226, the progressive-activity plan grouping recommendation 228, the progressive-activity plan grouping recommendation 228, the instructor recommendation management user interface (UI) 230, and a student recommended activity selector 232. Each engine or module includes software and executable code configured to perform and execute the functionalities described here.

In some embodiments, the RG system 118 is configured to receive data from a content-alignment system, such as the system described in U.S. Utility patent application Ser. No. 18/389,715, titled “Automated Alignment of Education Content” filed on Dec. 19, 2023, which claims priority to U.S. Provisional Patent Application No. 63/478,568, titled “Automated Alignment of Education Content,” filed on Jan. 5, 2023, wherein the entire contents of both applications are incorporated herein by reference. This data may be further aligned by an “Education Jurisdiction Alignment” module, to ensure that the educational content meets jurisdictional standards and requirements. The RG system 118 may maintain all the data in the data store 310 and also generate and maintain linking data that enables the data flow. The data store and database 310 includes student profiles 312, training data set(s) 316, machine learning models (ML) models, standards data sets 314, recommendation data sets 318, and teacher planning data sets 322. It should be recognized that all the data received or gathered through portals may be used to train the models described here.

Access to the RG system 118 via the network 102 may be provided to teachers and administrators in an academic environment or other educational setting, such as a school district. The data may include electronic resources (in a target language), which may be any electronic media for conveying information. For example, an electronic resource can be instructional in nature, and can convey knowledge, information, and resources to a user who interacts with or views it. As a further example, an electronic resource may include an instructional audio or video segment, a publication, an interactive instructional reference, a lesson plan, a planning tool, a community forum, a sharing tool, an industry standard, a portfolio tool, a progress monitoring tool, a reporting tool, etc. In some embodiments, an electronic resource can include any of textural data, graphical data, video data, audio data, etc. For example, the electronic resource may be a webpage including one or more of text, graphics, video, audio, etc. In another example, the electronic resource may be or include a downloadable or streamable media object, including, for example, an electronic document (e.g., portable document format (PDF) document), electronic book (e-book), digital video, digital audio file, vector graphics file, etc. In these or other examples, the electronic resource may include a dataset/electronic file with text, graphics, video, audio, etc. embedded therein.

In some embodiments, these electronic resources may convey information on various topics, such as student training, teaching skills, and similar subjects of consequence and importance to the growth and development of the users. For instance, for teachers an electronic resource may be an instructional video about an aspect of teaching, and a teacher may view the video by streaming it using his/her user device 106. In another example, the electronic resource may be a web-based interactive reference including text, audio, video, etc., and the teacher may study the reference by interacting with it via a client application 106 such as a web browser before determining that it is appropriate for a particular student, student group or a particular lesson plan.

The RG system 118, global in scope, may be tailored to provide preferences, not by the teacher or instructor alone, but in some instances, based on frameworks provided by institution, educational intent, jurisdictional standards, or the like. For the purposes of this disclosure, it should be recognized that education has many standards and preferences that must be met in a particular country, state, or district. Teacher preferences may be guided by these standards. For example, the common core state standards initiative in the U.S. is an educational initiative that details what K-12 students should know in English language arts and mathematics at the end of each grade. This initiative seeks to establish consistent educational standards across the states as well as ensure that students graduating from high school are prepared to enter credit-bearing courses at two or four-year college programs to enter the workforce. It should be recognized that the fifty states in the U.S. may have unique needs and standards for education. It should also be recognized that education standards, objectives, or goals vary across countries and also regions within countries, and continents. Different standards may be based on states or districts, or alternatively, provenance, agency, department, dioecy, federal etc. There also exist international educational frameworks and organizations. For example, the International Standard Classification of Education (ISCED) is a statistical framework for organizing information on education maintained by the United Nations Educational, Scientific and Cultural Organization (UNESCO). There are efforts underway to globalize educational standards. As another example, the European Education Area fosters collaboration among the European Union Member States to build more resilient and inclusive national education and training systems. Standardizing global educational organizations and practices via management systems help manage processes and activities to meet global objectives and goals. There are standardized curricula, learning, and tests that are used across the world. The standards and frameworks may require a varying range of skills. As an example, in the United States, national U.S. agencies may include the “Wisconsin Department of Public Instruction,” “Kansas State Department of Education,” “New York Department of Education,” and so on.

The content sources, either directly or via the content data store 115 (FIG. 1), may access the electronic resources stored in the data store 310. In some embodiments, the content data store 310 (FIG. 3) may collect information about the electronic resources (in target languages) from external sources or provide links to external sources. For instance, in some instances, the content data store 115 and the data store 310 may aggregate attributes of the electronic resources (target language specific), such as the author, publisher, file size, creation date, publication date, a thumbnail of the resource, etc., and store them in a resource library database (e.g., in memory 304 in FIG. 3). In various embodiments, the content data store 115 may access the content sources 111a-111n to transmit or stream copies of those resources to the user devices 106a-n of the users 114a-n requesting to interact with them.

The content sources are capable of receiving requests to populate the models generated for display on the user devices 106a-n and fulfilling those requests by transmitting the data to the corresponding user devices 106a-n of the users 114a-n. In one example, upon logging into or accessing (or otherwise connecting to) the RG system 118, a user device 106a may be presented with an interface by the user application 108a that may provide student-specific recommendations (e.g., in video, audio, text, etc.) for viewing. These may be generated based on inputs received from the instructor recommendation management UI or the student recommended activity selector UI. When users consume or interact with particular recommendations, records may be stored in the content data store 115 or the data stored 310 in association with those users. The records may include activities, events etc., and be used to generate the progressive activity plan grouping recommendations illustrated in FIG. 2.

In some embodiments, the user application 108a may monitor user interactions and with a user interface generated and displayed by the user application 108a, and record interaction data via the network 102. In a further example, if a user interacts with a media player embedded in a user interface of the user application 108a, further to a recommendation model, interaction data describing the user's interactions, such which actions the user took (e.g., clicked a pause button, a play button, a scrubbing dial, volume dial; maximized the viewing field of the media player; added a comment about the video using an associated interface element; etc.) may also be stored by the user application 108a or otherwise used.

In some embodiments, the user application 108a may generate and use presentational information to form the look and feel of the teacher/instructor user interfaces. For example, the electronic file(s) or data stream(s) may be formatted using a markup language (e.g., HTML, XML, etc.), style sheets (e.g., CSS, XSL, etc.), graphics, and/or scripts (e.g., JavaScript, ActionScript, etc.), and the client application 108a may interpret the interface instructions and render an interactive Web User Interface (WUI) for display on a user device 106a based thereon. In other implementations, the user application 108a may determine the formatting and look and feel of the user interfaces independently. Using the user interfaces presented by the client application 108a, the human user can input commands selecting various actions.

In some embodiments, the user-interface 119 (FIGS. 1 and 3), in cooperation with an observation engine (“Observation E” in FIG. 1), may generate a dashboard/interface (student recommended activity selector user interface (UI) or an instructor recommendation management UI) to provide viewing selections.

FIG. 3 further illustrates the various components coupled by a bus 306 to a communication unit 308, a processor 302, a memory 304, the data store 310 (also student content-data store 115 in FIG. 1) providing data for the aggregate student learning journey generated for a particular student, by providing different views, which may be displayed on display unit or device 410 (in FIG. 4) by a graphics adaptor 420 (FIG. 4). The RG system 118 is illustrated in FIG. 3 with the same components as in FIG. 1, however, with different reference numerals.

The processor(s) 302 processes data signals and program instructions received from the memory 304 and data storage (e.g., at other remote locations). The data store and database 310 is an example of the data storage. The processor 302 may comprise an arithmetic logic unit, a microprocessor, a general or special-purpose controller or some other array of processors configured to perform computations and provide electronic display signals to create the different views displayable in different languages via a display device (e.g., on a user device 106a). The different views as illustrated include student learning journeys as provided by the teacher planning models.

The processor 302 is coupled to the bus 306 for communication with the other components. The processor 302 may comprise various computing architectures including a complex instruction set computer (CISC) architecture, a reduced instruction set computer (RISC) architecture, or an architecture implementing a combination of instruction sets. Although only a single processor is shown in FIG. 3, multiple processors may be included. It will be obvious to one skilled in the art that other processors, operating systems, sensors, displays, and physical configurations than those that are illustrated may be used to perform the operations described in this specification.

The memory 304 may be a non-transitory storage medium. The memory 304 stores the instructions and/or data for operating RG system 118, which may be executed by the processor 302. In one implementation, the instructions and/or data stored in the memory 304 comprises code for performing any and/or all of the techniques or functionalities that are described in this specification. The memory 304 may be a dynamic random-access memory (DRAM) device, a static random-access memory (SRAM) device, flash memory or some other memory device known in the art.

The data storage (e.g., student content-data store 115 or data store/database 310) stores the data (e.g., in data sets) and program instructions that may be executed by the processor 302. In one implementation, the data storage may store the data of various types of users in the web forum. The data storage may include a variety of non-volatile memory permanent storage device and media such as a hard disk drive, a floppy disk drive, a CD-ROM device, a DVD-ROM device, a DVD-RAM device, a DVD-RW device, a flash memory device, or some other non-volatile storage device known in the art.

The communication unit 308 facilitates the communication (on line 104a-n) between the user device 106a-n (in FIG. 1) and the RG system 118 over the network 102 (in FIG. 1). For example, a user 114a, via the user device 106a, may access the RG system 118 to view or read language-specific electronic content and otherwise interact with the RG system 118 and receive information from the RG system 118, via the communication unit 308. The communication unit 308 also displays the content or information either received from or hosted via the RG system 118 to any of the users 114a through 114n.

The communication unit 308 couples to the RG system 118 via the network 102 by the signal line 116 (in FIG. 1) and via the bus 306. The communication unit 308 may include network interface modules, which include ports for wired connectivity such as but not limited to USB, SD, or CAT-5, etc. The network interface modules are configured to link the processor 302 to the network 102 that may in turn be coupled to other processing systems. The network or cloud platform 102 (FIG. 1) may comprise a local area network (LAN), a wide area network (WAN) (e.g., the Internet), and/or any other interconnected data path across which multiple devices may communicate. The network interface modules are configured to provide conventional connections to the network 102 using standard network protocols such as TCP/IP, HTTP, HTTPS and SMTP as well as any others that are understood to those skilled in the art. The network interface modules include a transceiver for sending and receiving signals using WIFI, Bluetooth® or cellular communications for wireless communication. Each of the platforms, modules, and/or engines described above may include software or program instructions configured to perform the functionalities described here.

The illustrated RG system 118 depicted in FIG. 3 (and FIGS. 1 and 2) is provided by way of example and it should be understood that it may take other forms and include additional or fewer components without departing from the scope of the present disclosure. For example, in some implementations, the RG system 118 may include an input device coupled to the data inputs engine 220 and output devices coupled to the model/data outputs engine 221 not shown separately but part of the communication unit 308 (e.g., a computer display, a keyboard and mouse, etc.). Additionally, it should be understood that the computer architecture depicted in FIG. 3 is applicable to the other entities of the RG system 118, such as the student content-data store 115 (in FIG. 1) and/or the content-alignment engine or server 117 (in FIG. 1) with various modifications.

The processor 302 includes an arithmetic logic unit, a microprocessor, a general-purpose controller, or some other processor array to perform computations and provide electronic display signals to a display device (not shown). The processor 302 may be coupled to the bus 306 for communication with the other components of the RG system 118. The processor 302 may process data signals and may have various computing architectures including a complex instruction set computer (CISC) architecture, a reduced instruction set computer (RISC) architecture, or an architecture implementing a combination of instruction sets. Although only a single processor 302 is shown in FIG. 3, multiple processors may be included. The processor 302 may be capable of supporting the display of images and the capture and transmission of images, performance of complex tasks, including various types of feature extraction and sampling, etc. It should be understood that the RG system 118 could include various operating systems, sensors, displays, additional processors, and other physical configurations.

The memory 304 stores instructions and/or data that may be executed by the processor 302. The memory 304 is coupled to the bus 306 for communication with the processor 302 and the other components of the RG system 118. The instructions and/or data may comprise code for performing any and/or all of the techniques described herein. In particular, the memory 304 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 302. A non-transitory computer-usable storage medium may include any and/or all computer-usable storage media. In some implementations, the memory 304 may include volatile memory, non-volatile memory, or both. For example, the memory 304 may include a dynamic random-access memory (DRAM) device, a static random-access memory (SRAM) device, flash memory, a hard disk drive, a floppy disk drive, a CD ROM device, a DVD ROM device, a DVD RAM device, a DVD RW device, a Blue-Ray™ storage device, a flash memory device, or any other mass storage device known for storing information on a more permanent basis. It should be understood that the memory 404 may be a single device or may include multiple types of devices and configurations.

The memory 304 includes a machine learning engine 304a and a data processing engine 304b. The machine learning engine 304a or other artificial intelligence is configured to gather data, aggregate data into datasets, make determinations, perform comparative functions, correlate data, generate scores and the like. The datasets that are created are used to create, build, and/or update the student models (generated by the data inputs engine 220 and the model/data outputs engine 221 and the various learning engines (aggregate student(s) learning journey(s) engine 222, the teacher-planning model engine 224, the teacher-feedback engine 226, etc). The machine learning engine 304a is coupled to a data processing engine 304b to compile datasets and train graphs and decision trees or maps and the various modeling engines in the application 118a with the various data sets that are compiled and used to process data inputs in real time. In some instances, the data may be generated by giving different weight factors to each of the types of data gathered. These weight factors may be determined by machine learning or other artificial intelligence and may be updated over time as the models change and adapt based on the data collected. The data processing engine 304b processes, correlates, integrates, and synchronizes the received data streams from disparate devices and data sources 111a-111n into a consolidated data stream as described herein. In some implementations, the data processing engine 304b instantiates a data ingestion layer that transports data from the assorted data sources (including the E-content data sources 111a-111n) to the data storage (115 or 310), where the data sets may be sorted, accessed, analyzed by the application and server 118. For example, the data ingestion layer processes incoming data, prioritizes sources, validates individual files, and routes the data to the data storage. In some implementations, the data processing engine 304b instantiates a data transformation layer that maps and converts data from a source format (e.g., of a E-content source) to a destination format. For example, the data transformation layer transforms non-XML data to XML data. The data processing engine 304b creates a user profile for a student user based on processing the received data streams. In some implementations, the data processing engine 304b may update a user profile that is already in the system. The user profile may include data and insights about the user including name, unique user identifier, age, gender, location, profile photo, user preferences, education goals, skill levels, activities etc.). The data processing engine 304b stores and updates the user profiles in the data storage.

In some implementations, the data processing engine 304b curates one or more training data sets based on the data streams received in association the user devices 106, in accordance with algorithms executed by server 118. The machine learning engine 304a described below uses the training datasets to train the machine learning models for performing various functionality as described herein. Example training datasets curated by the data processing engine 304b may include, but not limited to, a dataset on student skills, assessment trends, multilingual capabilities etc. Alternatively, data sets may include, data specific to jurisdictions. In some implementations, the aggregated data may be reviewed, segments identified and labeled, and stored in the data storage. The machine learning engine 304a may include software and/or logic to provide functionality for training one or more machine learning models or classifiers using the training datasets created or aggregated by the data processing engine 304b. The machine learning engine 304a is adapted to receive input from data scientists, analysts, or engineering staff to define and enhance the machine learning models. The machine learning engine 304a may also provide portals through which users can provide refinements and improvements to the models or introduce new models. In some implementations, the machine learning engine 304a receives and/or generates data, models, training data, and scoring parameters necessary to create the machine learning models.

For example, the machine learning engine 304a may provide curated data inputs, provide label identification hints and patterns, provide model negators, perform training, testing, approval and publish model versions, perform scoring model parameter tuning, or create scoring accuracy thresholds.

In some implementations, the machine learning engine 304a may be configured to incrementally adapt and train the one or more machine learning models every threshold period of time. For example, the machine learning engine 304a may incrementally train the machine learning models every hour, every day, every week, every month, etc. based on the aggregated dataset. In some implementations, a machine learning model is a neural network model and includes a layer and/or layers of memory units where memory units each have corresponding weights. A variety of neural network models may be utilized including feed forward neural networks, convolutional neural networks, recurrent neural networks, radial basis functions, other neural network models, as well as combinations of several neural networks. Additionally, or alternatively, the machine learning model may represent a variety of other machine learning techniques in addition to neural networks, for example, support vector machines, decision trees, Bayesian networks, random decision forests, k-nearest neighbors, linear regression, least squares, hidden Markov models, other machine learning techniques, and/or combinations of machine learning techniques. In some implementations, the machine learning engine 304a may train one or more machine learning models to perform a single machine learning task or a variety of machine learning tasks. In other implementations, the machine learning model may be trained to perform multiple tasks.

The machine learning engine 304a determines a plurality of training instances or samples from the labelled dataset curated by the data processing engine 304b. The machine learning engine 304a may apply a training instance as input to a machine learning model. In some implementations, the machine learning engine 304a may train the machine learning model using any one of at least one of supervised learning (e.g., support vector machines, neural networks, logistic regression, linear regression, stacking, gradient boosting, etc.), unsupervised learning (e.g., clustering, neural networks, singular value decomposition, principal component analysis, etc.), or semi-supervised learning (e.g., generative models, transductive support vector machines, etc.). Additionally, or alternatively, machine learning models in accordance with some implementations may be deep learning networks including recurrent neural networks, convolutional neural networks (CNN), networks that are a combination of multiple networks, etc. The machine learning engine 304a may generate a predicted machine learning model output by applying training input to the machine learning model. Additionally, or alternatively, the machine learning engine 304a may compare the predicted machine learning model output with a known labelled output from the training instance and, using the comparison, update one or more weights in the machine learning model. In some implementations, the machine learning engine 304a may update the one or more weights by backpropagating the difference over the entire machine learning model.

In some implementations, the machine learning engine 304a may test a trained machine learning model and update it accordingly. The machine learning engine 304a may partition the labelled dataset obtained from the data processing engine 304b into a testing dataset and a training dataset. The machine learning engine 304a may apply a testing instance from the training dataset as input to the trained machine learning model. A predicted output generated by applying a testing instance to the trained machine learning model may be compared with a known output for the testing instance to update an accuracy value (e.g., an accuracy percentage) for the machine learning model. Once a model is trained and tested, the model is then published and made available for turning predictions. In some implementations, the model may be versioned and serviced through an internal HTTP endpoint to be used by other component(s) of the application 118. In some implementations, model training, testing and publishing will be iterative, and adapted automatically. New versions will be published based on improvements based on training of historical data and efficiency calculations as more data is collected over a period of time.

The communication unit 308 is an interface for sending to and receiving data from other computing devices. In the illustrated embodiment, the communication unit 308 is coupled to the network 102 by the signal line 116 and coupled to the bus 306. In some embodiments, the communication unit 308 may include a network interface device (I/F) having ports for wired connectivity. For example, the communication unit 308 may include a CAT-5/6/7 interface, USB interface, or SD interface, etc. The communication unit 308 may also include a transceiver for sending and receiving signals using Wi-Fi, Bluetooth® or cellular communications for wireless communication. The communication unit 308 can link the processor 302 to the network 102 that may in turn be coupled to other processing systems. The communication unit 308 may provide connections to the network 102 and to other entities of the system 100 using standard communication protocols including, for example, TCP/IP, HTTP, HTTPS, etc.

The observation unit (designated as “OB-U” in the user interface generator 119) provided in the user interface 119 is software including routines for facilitating outputs received from the other engines of the RG system 118. In particular, the observation unit may send, receive and store recommendations and grouping data for observation, templates and files including questions and answers tied to performance standards (e.g., standards related to execution, compliance, effectiveness, personalized user plans, etc.), identify and suggest language-specific electronic learning resources based on observations, to generate related reports.

In the illustrated embodiment, the observation unit (OB-U in FIG. 1) cooperates with other engines and is coupled for communication with the other components of the RG system 118. The observation unit (OB-U in FIG. 1) is also coupled to the network 102 via the communication unit 308 for communication with the other entities of the system.

In some embodiments, the user interface 119 with the observation unit (OB-U in FIG. 1) may comprise sets of instructions executable by the processor 302 to provide their respective functionality. In other embodiments, these components are stored in the memory 304 and are accessible and executable by the processor 308 to provide their respective functionality. In any of these embodiments, these components may be adapted for cooperation and communication with the processor 302 and other components of the RG system 118.

The observation unit (OB-U in FIG. 1) is software including routines for sending, receiving, processing, and storing observation-related data. In some embodiments, the observation unit may provide observation templates to viewers for use in observing and assessing language-specific content.

The recommendations may be displayed to users via user interfaces generated and displayed by the user application 108. The user interfaces displaying the student-specific recommendation content of an observation template to a viewer may also provide functionality for completing the various fields within the template. For example, while observing a target subject in the field, a viewer may interact with interface elements presented by the user application 108 to input information about the recommendation-specific electronic content.

Referring now to FIG. 4, the communication unit 308 may have a display device 410, which may be any device equipped to present output signals generated and provided by the user device 106. In some embodiments, the display device 410 may be configured to display electronic images and data including, for example, specific user interfaces and formatted information for particular groups of students. For example, the display device 410 may be any conventional display device, monitor or screen, such as an organic light-emitting diode (OLED) display, a liquid crystal display (LCD), an e-ink display, etc. In some embodiments, the display device 410 may be a touch-screen display capable of receiving input from one or more fingers of a user 114a. For example, the display device 410 may be a capacitive touch-screen display capable of detecting and interpreting multiple points of contact with the display surface. In some embodiments, the display device 410 may be coupled to the bus 306 via the graphics adapter 420 (shown within the display device 410/communication unit 308, but also may be configured outside), which generates and provides display signals to the display device 410. The graphics adapter 420 may be a separate processing device including a separate processor 402 and memory 404 or may be integrated with the processor 302 and memory 304.

The input device 412 is provided within the communication unit 308 as illustrated and represents any device for inputting data to the user device 106. In some embodiments, the input device 412 may be a touch-screen display capable of receiving input from the one or more fingers of a user 114. The functionality of the input device 412 and the display device 410 may be integrated, and a user 114 of the device 106 may interact with the device 106 by contacting a surface of the display device 410 using one or more fingers. For example, the user 114a-n may interact with an emulated (i.e., virtual or soft) keyboard displayed on the touch-screen display by using fingers to contact the display device in the keyboard regions. In other embodiments, the input device 412 is a separate peripheral device or combination of devices. For example, the input device 412 may include a keyboard (e.g., a QWERTY keyboard) and a pointing device (e.g., a mouse or touchpad). The input device 412 may also include a microphone (e.g., for voice input) or other known peripheral devices.

The user application 108 is software including routines and executable code configured for sending and receiving data to the other entities of the system, including, for example, the RG system 118, the student content-data store 115, and the content alignment engine or server 117. In some embodiments, the user application 108a is a web browser application for accessing the resources provided by the RG system 118. For example, the RG system 118 operated in cooperation with the student content-data store 115 may be a web-based service and the user application 108 may access various electronic resources provided by the service via uniform resource locators (URLs). In other embodiments, the user application 108a is an application customized specifically for accessing the RG system 118, and more particularly, for cooperating and interacting with the observation unit.

In the illustrated embodiment, the user application 108 provides a user 114a-n (e.g., a student or teacher) interacting with the device 106 mechanisms for inputting viewing, adding, modifying, deleting selections-related data related to the electronic content.

In the illustrated embodiment, the user application 108 integrating the RG system 118 to users may include other user-interface module than the one illustrated here (user interface 119). While not shown, in some embodiments, the user application 108 may include an authentication or verification module for authenticating the user 114a-n to access the RG system 118.

In some embodiments, the user application 108, the user interface 119, and the other components illustrated, are sets of instructions executable by the processor 302 to provide their respective functionality. In other embodiments, the user application 108, the user interface 119, the observation unit, and/or either parts of or wholly, the other components and engines may be stored in the memory 304 of the user device 106 and are accessible and executable by the processor 302 to provide their functionalities. It should be recognized that the observation unit may send interface signals to the RG system 118, and responsive to receiving these signals, the user interface 119 may generate and display user interfaces that correspond to the instructions carried by the interface signals. In another example, the user interface 119 may receive input signals via the input device 412 and send those signals to the observation unit (in the user interface 119) for processing. In some embodiments, the user-interface 119, via the observation unit, may receive information and display the information to users, populate observation templates for user input, save selection files based on the observation templates, transmit selection-related data such as observation files to the observation unit or storage, receive language-specific selection-related statistics and reports and organize and display them to the user or others, receive electronic resources for consumption, etc.

The user interface 119 may be software including routines for rendering user interfaces and for receiving user input. The user interface may be coupled to the input device via the bus 306 to receive input signals from the user 114a-n. For example, an observer/user 114a-n can select an answer to a selection-related question using the input device, and the user-interface module receives signals describing the answer. The user interface 119 may store the input signals in the memory 304 for retrieval by the other elements of the client application 108.

The student-specific user interfaces generated by user interface 119 may include interfaces for different students for inputting, modifying, and deleting information, displaying notifications, rendering video, displaying images and text, displaying vector-based content, sending and storing information, etc. In some embodiments, the user interfaces include user interface elements that allow users 114a-n to interact with the user device 106 and input information and commands, such as text entry fields, selection boxes, drop-down menus, buttons, virtual keyboards and numeric pads, etc.

Referring to FIG. 4, the RG system 118 comprises a processor 402, a memory 404, and the recommendations application 108, which further comprises a user-interface module 414, an observation unit 416, and a feedback unit 418. In addition, the RG system 118 includes the communication unit 408 coupled to the other servers and the network via signal line 104 and other components illustrated in FIG. 2.

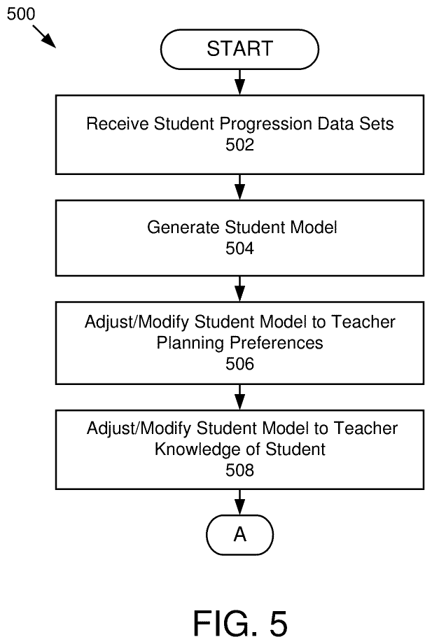

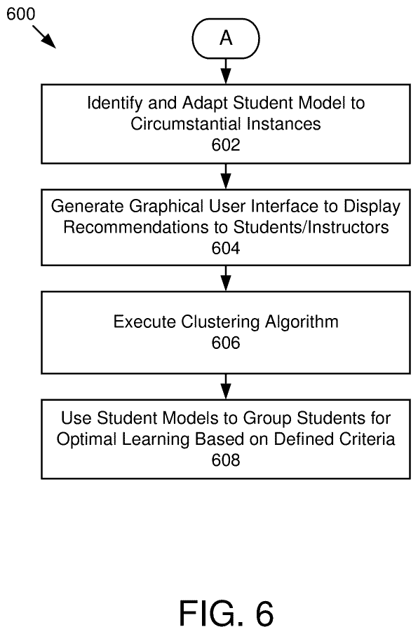

Referring now to FIG. 5, an example method 500 for generating recommendations and groupings, by the various components illustrated in FIGS. 1 and 2, starts at block 502, including one or more operations for receiving student progression data. The method 500 proceeds to the next step 504, which includes one or more operations for generating student models. The method 500 proceeds to the next block 506, which includes one or more operations for adjusting student models to teaching planning preferences. The method 500 proceeds to the next block 508, which includes one or more operations for adjusting student model to teacher knowledge of the student through connector A to the next block in FIG. 6. The method 600 proceeds to block 602, which includes one or more operations for adapting the student model to circumstantial instances. The method 600 proceeds to the next block 604, which includes one or more operations for generating a graphical user interface to display recommendations to students/instructors. The method 600 proceeds to the next block 606, including one or more operations for executing clustering algorithm. The method 600 proceeds to the next block, including one or more operations for, using student models to group students for optimal learning based on defined criteria.

An example recommendation and grouping system and method is described. In the above description, for purposes of explanation, numerous specific details are set forth in order to provide a thorough understanding of the present disclosure. It should be understood that the technology described in the various example embodiments can be practiced without these specific details. In other instances, structures and devices are shown in block diagram form in order to avoid obscuring the description.

Reference in the present disclosure to “some embodiments,” “an embodiment,” “an example embodiment,” “other embodiments,” etc., means that a particular feature, structure, or characteristic described in connection with the embodiment is included in at least one embodiment of the description. The appearances of the phrase “in some embodiments” in various places in the present disclosure are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including, for example, “processing” or “computing” or “calculating” or “ranking” or “identifying” or “determining” or “displaying” or “receiving” or “conducting” or “collecting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the present disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium including, for example, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The present disclosure can take the form of an entirely hardware embodiment, an entirely software embodiment or an embodiment containing both hardware and software elements. In a preferred embodiment, the present disclosure is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, wireless adapters, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description. In addition, the present disclosure is not described with reference to any particular programming language. It will be appreciated that a variety of programming languages may be used to implement the teachings of the present disclosure as described herein.

It is intended that the scope of the disclosure should not be limited by this particular detailed description. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
in a server, with one or more processors and a memory, using executable code stored in the memory to cause the one or more processors to execute control actions over a network to:
receive, using the one or more processors at the server, over the network, student progression data sets for a plurality of different students from one or more content sources;
generate, using the one or more processors at the server, over the network, a plurality of learning progression models specific to each of the plurality of different students;
receive, using the one or more processors, one or more inputs designating teacher planning preferences;
modify the plurality of learning progression models based on the teacher planning preferences;
modify the plurality of learning progression models based on the teacher knowledge of the plurality of students;
identify circumstantial instances and adapt the plurality of learning progression models based on the circumstantial instances;
generate a graphical user interface for the plurality of students to display one or more recommendations to users;
execute a clustering algorithm in a machine learning engine; and
use the plurality of student models to group students for optimal learning patterns, based on defined criteria.

2. The computer-implemented method according to claim 1, wherein the users are either students or instructors.

3. The computer-implemented method according to claim 1, wherein the student progression models are trained by data sets including student assessment and performance data points.

4. The computer-implemented method according to claim 1, wherein the student progression models are trained by data sets including daily skill practice data and daily skill performance data points.

5. The computer-implemented method according to claim 1, wherein the executable code stored in the memory further causes the one or more processors to execute control action over the network to:
provide an output in a user interface, wherein the output indicates a student growth pattern and a growth rate.

6. The computer-implemented method according to claim 1, wherein the executable code stored in the memory further causes the one or more processors to execute control action over the network to:
provide an output in a user interface, wherein the output indicates a student skill mastery.

7. The computer-implemented method according to claim 1, wherein the executable code stored in the memory further causes the one or more processors to execute control action over a network to:
provide a student intervention program.

8. The computer-implemented method according to claim 7, wherein student activity, skill, difficulty, and metadata are assessed.

9. The computer-implemented method according to claim 1, wherein the teacher planning preferences are generated by a teacher planning model configured to define a planning purpose, one or more planning configuration preferences, a teacher student knowledge graph, a representation of time allotment, an indication of lost instructional time, and one or more selected educational alignments.

10. The computer-implemented method according to claim 9, wherein the teacher planning model is built with teacher feedback provided in real time.

11. A system comprising:
a server, comprising one or more processors;
a memory coupled to the one or more processors, storing executable code configured to cause the one or more processors to execute control action over a network to:
receive, using the one or more processors at the server, over the network, student progression data sets for a plurality of different students from one or more content sources;
generate, using the one or more processors at the server, over the network, a plurality of learning progression models specific to each of the plurality of different students;
receive, using the one or more processors, one or more inputs designating teacher planning preferences;
modify the plurality of learning progression models based on the teacher planning preferences;
modify the plurality of learning progression models based on the teacher knowledge of the plurality of students;
identify circumstantial instances and adapt the plurality of learning progression models based on the circumstantial instances;
generate a graphical user interface for the plurality of students to display one or more recommendations to users;
execute a clustering algorithm in a machine learning engine; and
use the plurality of student models to group students for optimal learning patterns, based on defined criteria.

12. The system according to claim 11, wherein the users are either students or instructors.

13. The system according to claim 11, wherein the student progression models are trained by data sets including student assessment and performance data points.

14. The system according to claim 11, wherein the student progression models are trained by data sets including daily skill practice data and daily skill performance data points.

15. The system according to claim 11, wherein the executable code stored in the memory further causes the one or more processors to execute control action over the network to:
provide an output in a user interface, wherein the output indicates a student growth pattern and a growth rate.

16. The system according to claim 11, wherein the executable code stored in the memory further causes the one or more processors to execute control action over the network to:
provide an output in a user interface, wherein the output indicates a student skill mastery.

17. The system according to claim 11, wherein the executable code stored in the memory further causes the one or more processors to execute control action over a network to:
provide a student intervention program.

18. The system according to claim 11, wherein student activity, skill, difficulty, and metadata are assessed.

19. The system according to claim 11, wherein the teacher planning preferences are generated by a teacher planning model configured to define a planning purpose, one or more planning configuration preferences, a teacher student knowledge graph, a representation of time allotment, an indication of lost instructional time, and one or more selected educational alignments.

20. The system according to claim 11, wherein the teacher planning model is built with teacher feedback provided in real time.
